(19) United States
(12) Patent Application Publication
(10) Pub. No.: US 2024/0112599 A1
(43) Pub. Date: Apr. 4, 2024

(54) ASSISTIVE DEVICE AND METHOD

(71) Applicant: Moskowitz Family LLC, Rockville, MD (US)

(72) Inventors: Mosheh T. Moskowitz, Rockville, MD (US); Nathan C. Moskowitz, Rockville, MD (US)

(21) Appl. No.: 18/372,914

(22) Filed: Sep. 26, 2023

Related U.S. Application Data
(60) Provisional application No. 63/411,943, filed on Sep. 30, 2022.

(51) Int. Cl. G09B 21/00; A61H 3/06; B64U 70/50; B64U 80/60; G05D 1/10; G06F 3/01; G08B 7/00

(52) U.S. Cl. CPC G09B 21/007; A61H 3/068; B64U 70/50; B64U 80/60; G05D 1/101; G06F 3/015; G06F 3/016; G08B 7/00; B64U 2101/30

(57) ABSTRACT

An assistive apparatus for sensing the environment in the vicinity of a user, and provide feedback signals generated based on the sensing data to the user. The assistive apparatus includes a sensing device configured to collect data characterizing the environment, a processing device, including one or more processors, configured to process an input including the collected data into presentation data specifying an audio signal and/or a haptic signal, and a presentation device configured to deliver the audio signal or the haptic signal to the user.

### CROSS-REFERENCE TO RELATED APPLICATION

This application claims priority to U.S. Provisional Patent Application No. 63/411,943, filed on Sep. 30, 2022, the disclosure of which is hereby incorporated by reference in its entirety.

### TECHNICAL FIELD

This specification relates to method and apparatus for providing assistance to people with disabilities, and in particular, for providing assistance to people with visual impairment.

### BACKGROUND

According to the World Health Organization, there are approximately 285 million visually impaired people throughout the world. Out of these, 39 million are blind, and 246 million have low vision.

Assistive technology provides equipment, software programs, or product systems for maintaining or enhancing the functional capabilities of persons with disabilities. In particular, to people with visual impairment, assistive technology provides assistance in sensing the environment.

### SUMMARY

This specification provides an assistive apparatus for sensing the environment in the vicinity of a user, and provides feedback signals generated based on the sensing data to the user, for example, to a visually-impaired person. The assistive apparatus includes a sensing device configured to collect data characterizing the environment, a processing device, including one or more processors, configured to process an input including the collected data into presentation data specifying an audio signal and/or a haptic signal, and a presentation device configured to deliver the audio signal or the haptic signal to the user.

In another aspect, this specification provides a method for providing assistance to a user by using the assistive apparatus described above. The method includes deploying a sensor to collect data from an environment, receiving the collected data from the sensor, processing the sensor data into audio or haptic signals, and outputting the audio/haptic signals to the user.

The subject matter described in this specification can be implemented in particular implementations so as to realize one or more advantages. In general, the assistive apparatus described herein helps a visually-impaired person to compensate for or enhance the impaired visual sensing of the immediate environment, and thus improves the safety and quality of life of the person.

In some implementations, the assistive apparatus includes an unmanned aerial vehicle (UAV) or a robotic ground vehicle that incorporates sensors for collecting data characterizing the environment. Since the UAV or robotic ground vehicle can navigate the environment in the vicinity of the user, the sensing of the environment is not limited by the sensor's field of view. Further, the UAV or robotic ground vehicle can provide physical guidance to the user, e.g., via a tether. Some examples of the UAV have a compact and foldable design, and can be controlled to deploy and return to storage, thus improving the convenience of use. In some implementations, the assistive apparatus further includes a UAV launching device for launching the UAV.

In some implementations, the assistive apparatus includes a cane or a walking stick that incorporates multiple types of sensors to collect data from the environment. The multiple sensors can provide comprehensive information, e.g., via multi-modality and multi-directional sensing, while being incorporated in an item that the visually impaired already uses, and thus provide enhanced safety and convenience to the user.

In some implementations, the assistive apparatus includes a presentation device that provides haptic signal to the user encoding the environment information in real time. For example, rings incorporating haptic arrays can be worn by the user on the fingers, and present Braille-type messages to the user in real-time. In another example, a haptic array can be used to deliver an image to the user depicting the environment in real time. By using these presentation devices, the user can gain information in an efficient and intuitive manner. In some examples, the presentation device is a wearable device for conveying 3D shapes through haptic feedback. For example, the presentation device can be a glove configured with mechanics on each finger joint, connection mechanisms connecting the joint mechanics, and actuators for providing haptic feedback to the user through the glove. In some other examples, the presentation device can be a shoe that includes vibration elements to relay vibration patterns for providing direction cues for the user. In some other examples, the presentation device can include a wearable device for assisting movements of the user. In some other examples, the presentation device can include a shape presentation device that includes a 3D grid and actuators to reshape the 3D grid.

In some implementations, the assistive apparatus includes a brain signal sensing device configured to measure signals from the user brain, analyze the measured signals to infer a user intention, and relay a user command based on the inferred user intention to the assistive apparatus to assist the user.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example of an assistive apparatus.

FIGS. 2A-2D show configurations of an example of a sensing device.

FIGS. 3A-3D show additional configurations of the example of the sensing device.

FIGS. 4A-4E show configurations of another example of a sensing device.

FIGS. 5A-5C show configurations of another example of a sensing device.

FIGS. 6A-6C show configurations of another example of a sensing device.

FIGS. 7A and 7B show configurations of another example of a sensing device.

FIG. 8 shows another example of a sensing device.

FIGS. 9A-9C show configurations of another example of a sensing device.

FIG. 10 shows an example of a presentation device.

FIGS. 11A and 11B shows another example of a presentation device.

FIG. 12 shows another example of a presentation device.

FIG. 13 shows another example of a presentation device.

FIGS. 14A and 14B show examples of a brain signal sensing device.

FIGS. 15A and 15B show examples of a UAV launching device.

FIGS. 16A, 16B, and 16C show an example of a presentation device.

FIG. 17 shows another example of a presentation device.

FIG. 18 shows another example of a presentation device.

FIGS. 19A-19C show another example of a presentation device.

FIG. 20 shows a user using an example of an assistive apparatus in an environment.

FIG. 21 shows a method for providing assistance to a user.

FIG. 22 shows an example of a computer system being used as a processing device.

### DETAILED DESCRIPTION

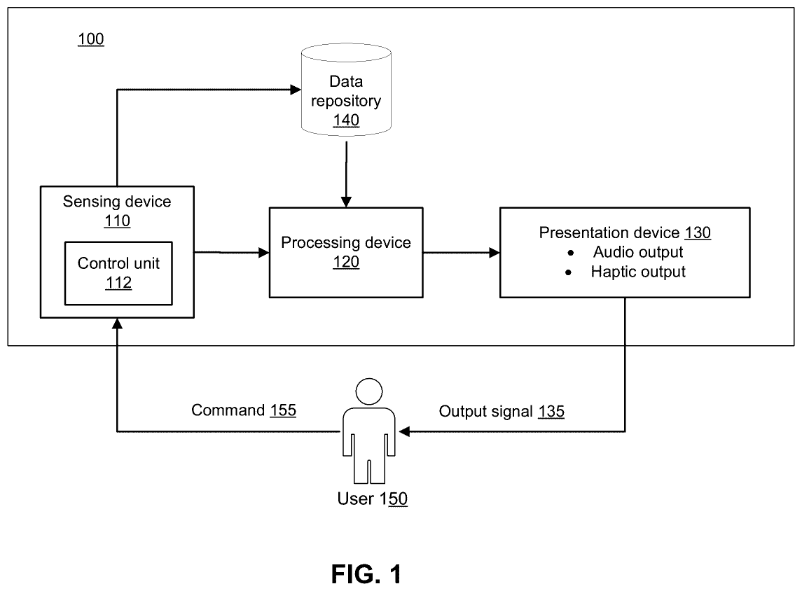

FIG. 1 shows an example of an assistive apparatus 100. The assistive apparatus 100 includes a sensing device 110 configured to collect data characterizing an environment in the vicinity of a user 150, a processing device 120 configured to process an input including the collected data into presentation data, and a presentation device 130 configured to deliver the presentation data as an output signal 135 to the user.

In general, the presentation data can define an audio signal and/or a haptic signal to be delivered by the presentation device 130 to the user, so the assistive apparatus 100 is suitable to present the data collected by the sensing device 110 to a person having visual impairment.

In general, the sensing device 110 can include any suitable type of sensors for collecting and recording the data characterizing the environment. For example, the sensing device 110 can include a camera that collects images or videos of the environment. In another example, the sensing device 110 can include a Lidar that collects three-dimensional (3D) point clouds characterizing the environment. In another example, the sensing device 110 can include a Sonar that collects sonograms, sound wave echoes, and/or Doppler signals characterizing the environment.

In some implementations, the sensing device is further configured to transmit the collected data to a data repository 140 shared by multiple users to achieve crowdsourcing of sensor data. For example, the data repository 140 can be configured on a server that can be accessed by multiple devices like the assistive apparatus 100. Sensor data collected by different devices can be stored in the data repository 140 as structured data categorized by geolocations where the sensor data is collected, time stamps of the collected sensor data, type of sensor data, and so on. The processing device 120 of a particular assistive apparatus 100 can receive relevant data (e.g., sensor data collected at the same geolocation as the current location of the user of the particular assistive apparatus) from the data repository 140 and process the received data into the presentation data.

In some implementations, the sensing device 110 can include an unmanned aerial vehicle (UAV) configured to be controlled by a control unit 112 (including one or more computer processors) to navigate the environment in the vicinity of the user, collect sensor data using a sensor onboard the UAV, and transmit the sensor data to the processing device. Since the UAV is capable of navigating the environment, the sensing device is not limited by the field of view or a fixed position of the onboard sensor, e.g., a camera. The navigation path of the UAV can be controlled by the control unit based on user commands (e.g., via speech or gesture recognition), pre-configured programs, and/or machine-learning algorithms.

In some implementations, the control unit 112 is configured to receive a user command 155 from the user 150, enabling the user 150 to provide instructions to the apparatus 100. For example, the user command 155 can be “Survey the area to my left,” instructing the sensing device 110 to focus its surveying efforts on a specific directional cue. In another instance, the user command 155 can state “Guide me to the nearest exit,” specifying a destination the user aims to reach. Another example can be the user stating “Find me a clear path to sit down,” representing a specific task the user wishes to achieve. In response to the user command 155, the control unit 112 can identify and direct the sensing device 110 to inspect the relevant sections of the environment to facilitate the user's request.

The user command 155 can take various forms of data input. It can be a voice command, which the apparatus 100 processes through a voice-to-speech conversion module. Alternatively, the user command 155 can be in the form of a gesture, prompting the apparatus 100 to interpret the gesture via a gesture interpretation module. In both cases, the user can give instructions without needing to see the apparatus. Thus, the assistive apparatus 100 can be equipped one or more components to effectively understand and translate different forms of user commands into actionable instructions for the sensing device 110.

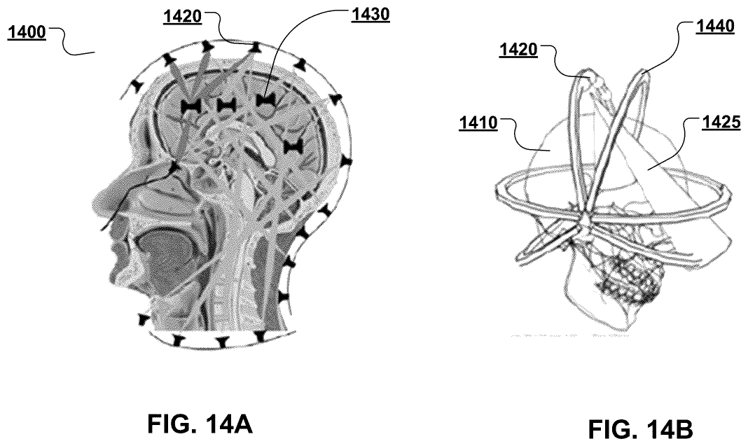

In some implementations, the control unit 112 can obtain the user command 155 by analyzing signals measured from the brain of the user. FIGS. 14A and 14B show examples of a brain signal sensing device 1400 for obtaining brain signals from the brain 1410 of the user.

The brain signal sensing device 1400 includes one or more sensors for measuring signals from the user brain 1410. The sensors can include external sensors 1420 and/or internal sensors 1430 that have been implanted in the user brain 1410. The measured signals can be any appropriate brain signals, such as electroencephalography (EEG), magnetoencephalography (MEG), functional near-infrared spectroscopy (fNIRS), or electrocorticography (ECoG). The brain signal sensing device 1400 can analyze the measured signals, e.g., by processing the signals using a trained machine learning model, to infer a user intention. For example, the brain signal sensing device 1400 can generate data indicating the user intention, such as “I want to get a cup of coffee” or “I want to walk from here to home.”

The brain signal sensing device 1400 can be implemented in a variety of ways. For example, the sensors 1420 can be fixed on one or more rotatable frames 1440 to scan different locations. In some cases, the sensors 1420 can include transducers (e.g., an NIR transducer) that transmit a scanning signal 1425. In some cases, the sensors 1420 and 1430 measure a brain signal (e.g., an EEG signal) without using a transducer. The machine learning model used to analyze brain signals can be trained on a dataset of human brain activity that has been labeled with the corresponding user intentions. The dataset can be generated by asking people to perform different tasks while their brain activity is being recorded.

The brain signal sensing device 1400 can be used to improve the quality of life for people with disabilities, including visually impaired individuals, who have difficulty communicating or controlling their environment.

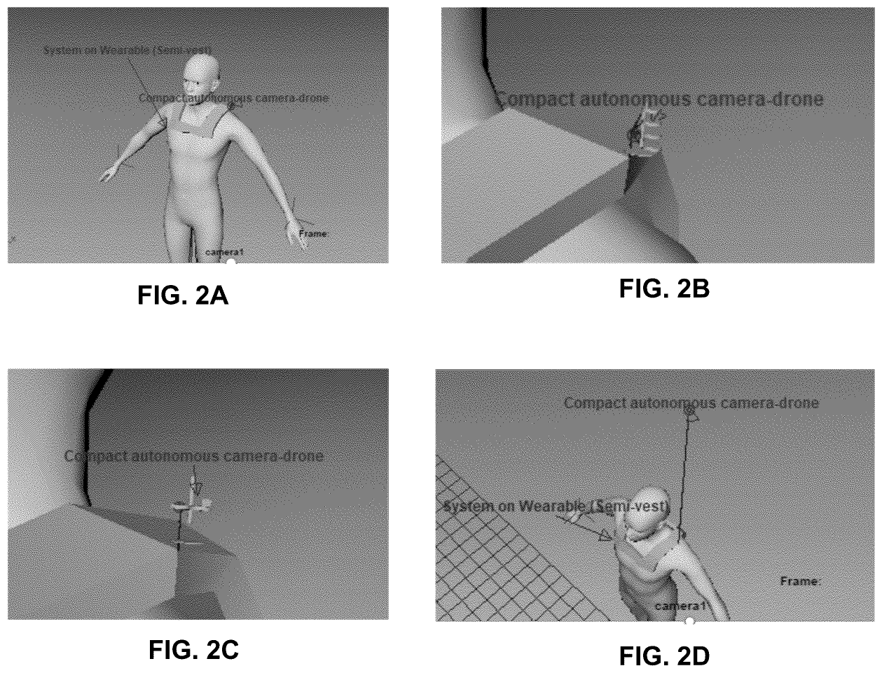

FIGS. 2A-2D show an example of a sensing device including a UAV. In particular, the UAV is controlled by the control unit to be deployed from and to navigate the environment and return to a storage housing of a wearable device (e.g., a vest worn by the user) when the UAV is not being deployed.

In some implementations, the UAV is controlled (e.g., by the control unit) to reconfigure between a resting configuration for storage and a deployed configuration for flight tasks. That is, the UAV can include one or more actuators to rearrange components of the UAV so that the UAV can have a compact overall shape for convenience of storage.

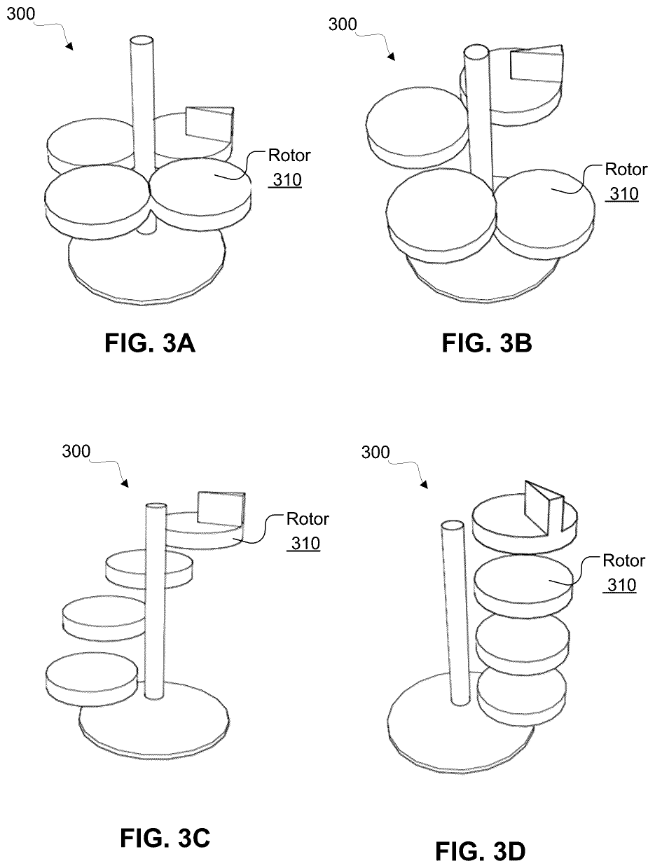

FIGS. 3A-3D show an example of the UAV 300 transforming from the deployed configuration (FIG. 3A) to the resting configuration (FIG. 3D). As shown in FIGS. 3A-3D, the UAV includes a plurality of rotor discs 310. When rearranging the UAV from the deployed configuration to the resting configuration, the control unit controls the actuators to rearrange the rotation axles of the rotor discs to align the rotation axles into a linear alignment with each other. As shown in FIG. 3D, in the resting configuration, all 4 rotor discs 310 of the UAV are aligned with each other, resulting in a compact cylindrical profile of the UAV 300 for convenience of storage.

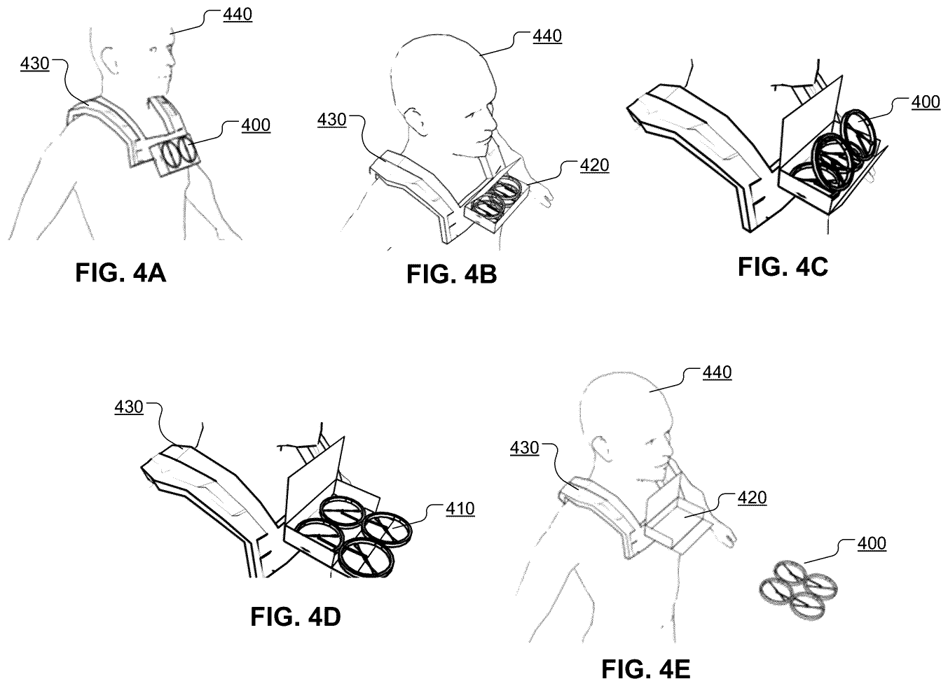

FIGS. 4A-4E show another example of the UAV transforming from the resting configuration (FIG. 4A) to the deployed configuration (FIG. 4D). As shown in FIG. 4A, in the resting configuration, the UAV 400 is folded with two of the rotor discs 410 being aligned with the other two rotor discs, and the folded UAV 400 is stored in a storage compartment 420 attached to a vest 430 worn by the user 440. When deploying the UAV 400, the storage compartment 420 opens, and the UAV 400 is unfolded and flies out of the storage compartment 420, as shown in FIGS. 4B-4E.

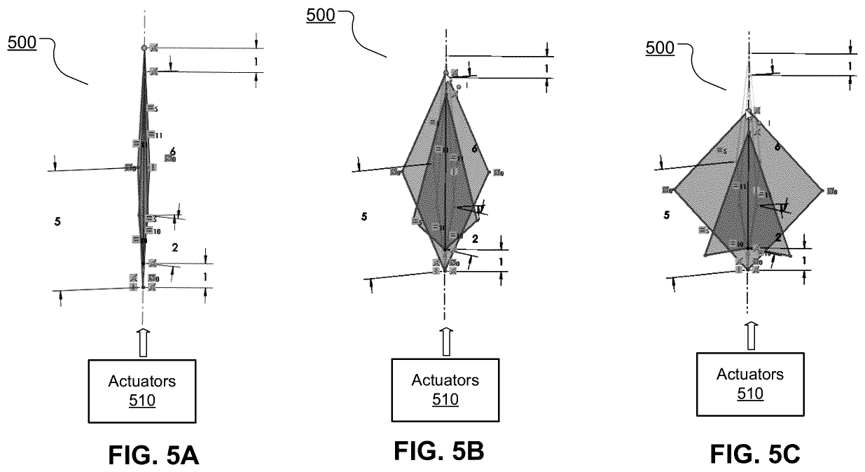

In some implementations, the UAV includes a frame structure that has an elongated shape in the resting configuration, and when rearranging the UAV from the resting configuration to the deployed configuration, actuators are controlled to expand the width and shorten the height of the elongated shape of the frame structure. FIGS. 5A-5C show an example of the UAV of this type. As shown in FIGS. 5A-5C, in the resting configuration (FIG. 5A), the UAV 500 is folded, e.g., by the actuators 510 into an elongated shape for convenience of storage. When deploying the UAV 500, the UAV 500 is unfolded by the actuators 510 with wing structures 510 being spread out (FIG. 5C) for the UAV to perform light tasks.

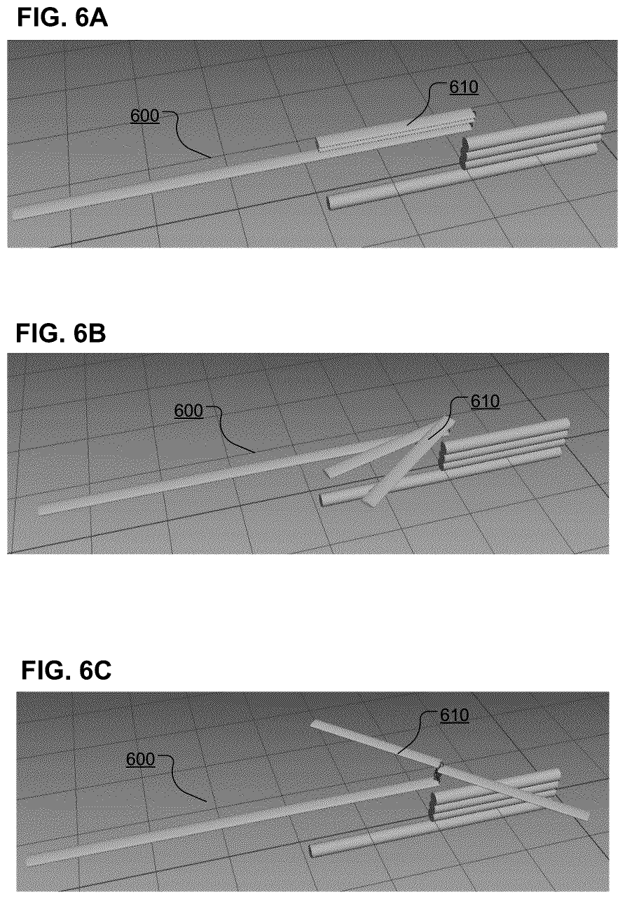

In some implementations, instead of rotor discs, the UAV has one or more propellers each including a plurality of rectangular propeller blades that are rotatably coupled to an axle. FIGS. 6A-6C show an example of such a UAV. As shown in FIG. 6A, in the resting configuration, the plurality of rectangular blades 610 of the UAV 600 are aligned with each other so that the UAV has a compact profile convenient for storage. When the UAV is in flight, one or more of the rectangular propeller blades 610 are driven by one or more motors to rotate to provide the driving force for the flight.

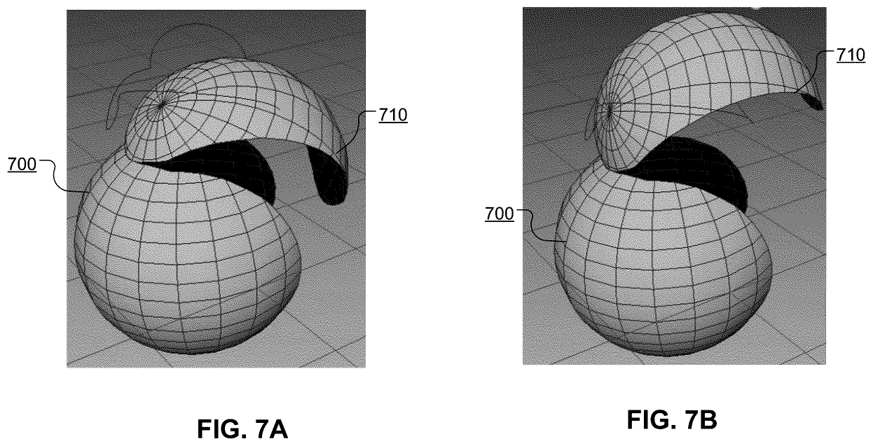

FIGS. 7A and 7B show another example of the UAV. The UAV 700 has a spherical shape when in the resting configuration, and during the transformation from the resting configuration to the deployed configuration, one or more movable portions 710 (e.g., wing structures) spread out to transform the spherical shape from a closed to an open position (FIG. 7B).

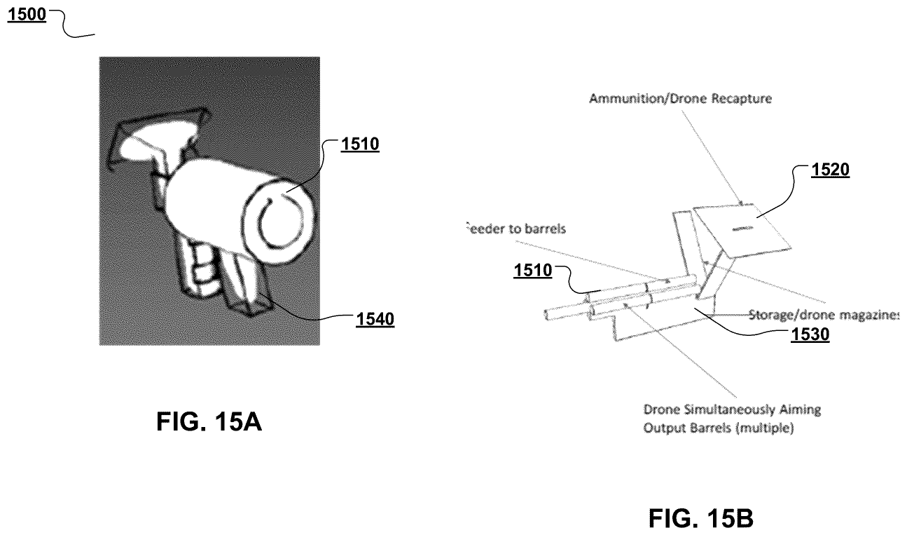

In some implementations, the UAV can be launched by a launching device. FIGS. 15A and 15B illustrate examples of a UAV launching device 1500 designed to deploy UAVs swiftly and efficiently. The device 1500 can feature a single barrel 1510 for launching UAVs, as depicted in FIG. 15A, or can incorporate multiple barrels 1510, potentially facilitating the simultaneous launch of several UAVs, as demonstrated in FIG. 15B. The launching device 1500 can be handheld and compact. It can include a trigger 1540, allowing users the option to initiate the UAV's deployment. Furthermore, the device 1500 can include a portion 1520 for UAV retrieval and another portion 1530 that can be used for UAV storage.

A design aspect of the launching device 1500 is the barrel, which can serve to house the UAV and also guide its trajectory during launch. Upon deployment from the barrel, a UAV can automatically deploy an unfolding mechanism. While it can be compactly folded to fit within the barrel initially, the UAV can start to expand, potentially taking on its operational form immediately after ejection. Moreover, a UAV can be outfitted with its own propulsion system, enabling it to achieve flight shortly after being launched.

The UAV launching device 1500 can use various ejection mechanisms to ensure optimal launch conditions. One example mechanism can utilize a high-pressure pneumatic setup, where compressed air propels the UAV rapidly. Alternatively, the device 1500 can employ a spring-loaded mechanism, where a rapidly decompressing coil spring provides the force for UAV deployment.

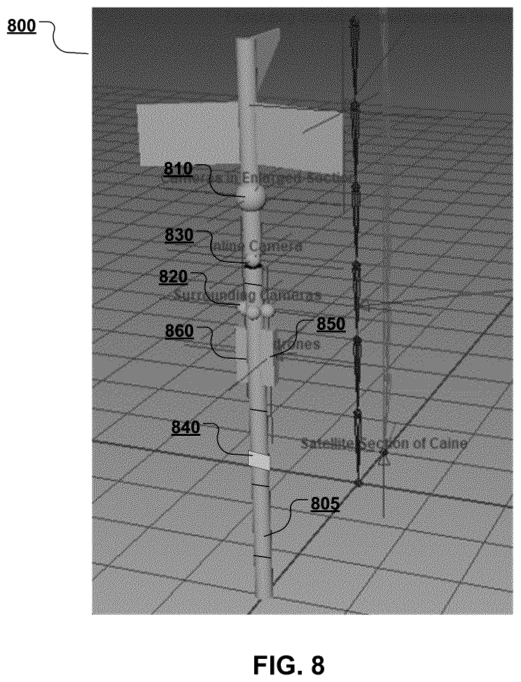

In some implementations, the sensing device includes an elongated pole (e.g., a walking stick) incorporated with one or more sensors configured to collect sensor data of the environment, and transmit the sensor data to the processing device. FIG. 8 shows an example of the walking stick. The walking stick 800 includes one or more cameras 810 (e.g., a plurality of surrounding cameras 820 and one or more in-line cameras 830 for collecting images from different angles). The walking stick 800 can be further incorporated with a GPS device 840 for determining the location of the device. The walking stick 800 can further include a UAV 850 configured to be housed in a storage housing 860 of the walking stick 800 when the UAV 850 is in the resting position and deployed to navigate the environment. In some implementations, the walking stick 800 can include a plurality of sections 805 coupled together and configured to expand from a retracted to an expanded configuration.

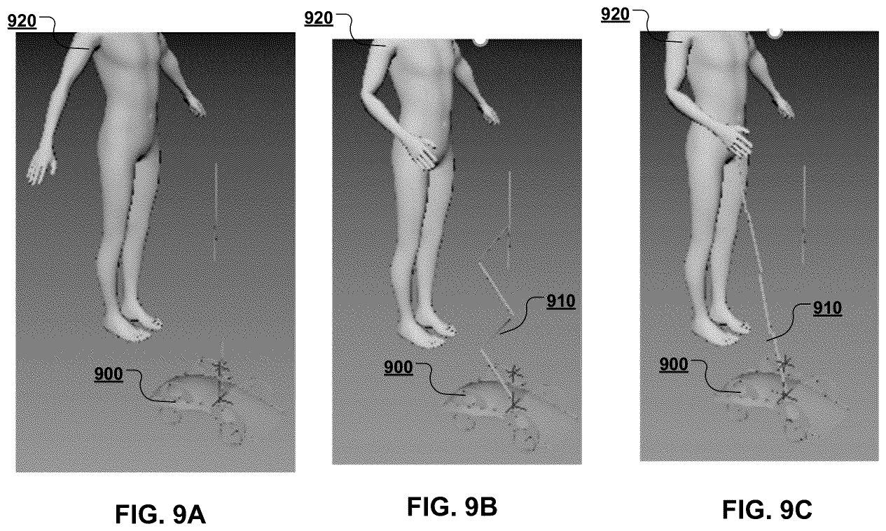

In some implementations, the sensing device includes a mobile robotic device that is configured to navigate the environment in the vicinity of the user, collect sensor data using a sensor onboard the mobile robotic device, and transmit the sensor data to the processing device. FIGS. 9A-9C show an example of such device, e.g., a robotic ground vehicle 900. As shown in FIGS. 9A-9C, the mobile robotic device 900 can be connected to an expandable and actuated tether 910 that is configured to be expanded or contracted. When the user 920 holds the expanded tether 910, the mobile robotic device 900 can be used to physically guide the user 920 to navigate the environment. In some implementations, the mobile robotic device 900 can be further configured to be controlled by a voice command to perform a task, e.g., fetch an object for the user 920.

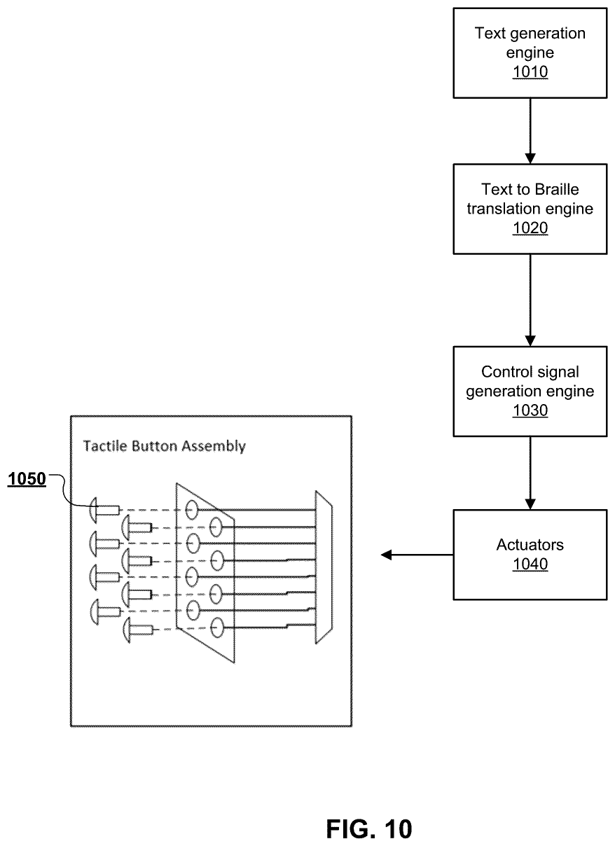

In some implementations, the presentation device includes one or more arrays of actuated pegs that are controlled, by a control signal generated according to the presentation data, to move in an axial direction to form one or more patterns. In particular, the one or more arrays of actuated pegs can be controlled by a control signal to form one or more patterns of Braille-type characters to present the Braille-type text segment to the user. FIG. 10 shows an example of such an implementation. As shown in FIG. 10, a text generation engine 1010 generates text data specifying a text segment based on the collected data, the text to Braille translation engine 1020 processes the text data to generate Braille data specifying a Braille text segment that is a translation of the text segment, and the control signal generation engine 1030 processes the Braille text segment to generate the control signal to control the actuators 1040 to move the actuated pegs 1050 in the array to form the patterns of Braille-type characters.

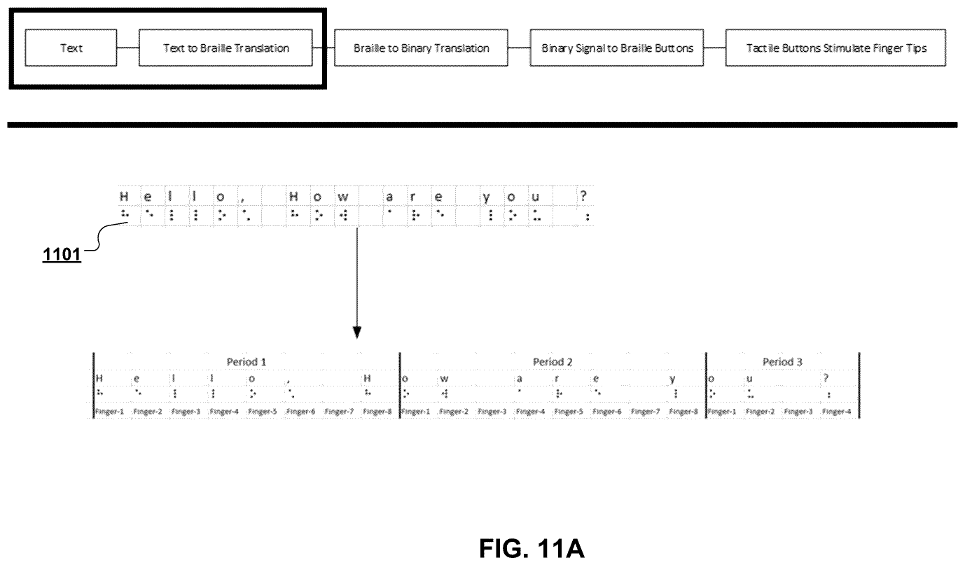

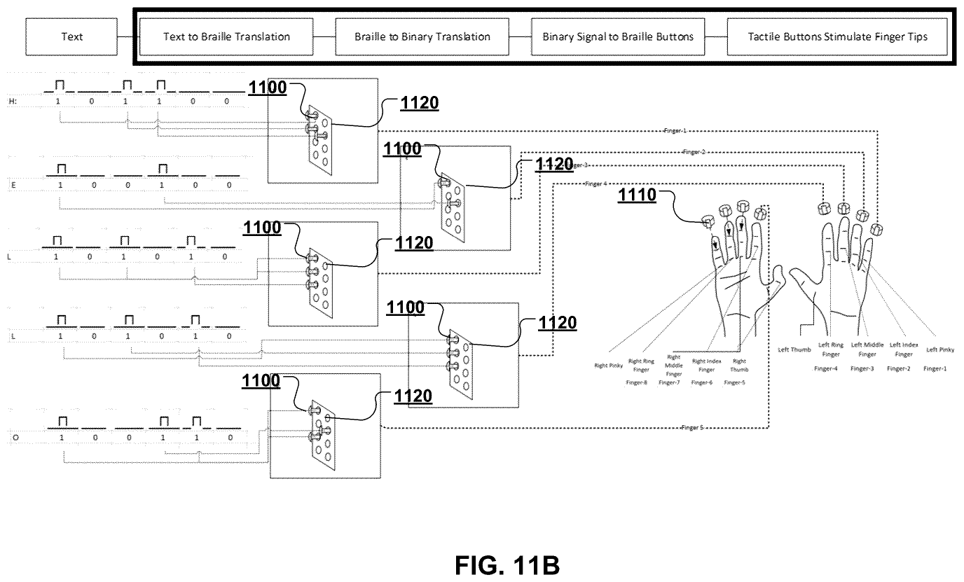

In some implementations, as shown in FIG. 11B, one or more arrays of actuated pegs 1100 are incorporated into one or more wearable rings 1110. When being worn on the fingers by the user, the rings 1110 can present multiple Braille-type characters in a Braille text segment (e.g., one or more words) at a particular time point. When the patterns of the peg arrays 1100 are controlled to be changed at multiple different time points, multiple segments of the Braille text can be delivered to the user via one or more of the rings to provide tactile feedback to stimulate the user's finger tips.

FIGS. 11A and 11B further show an example of generating the control signals to move the actuated pegs 1100 to form the Braille text for a sentence such as “Hello how are you?” As shown in FIG. 11A, each letter in the sentence is translated to a Braille symbol 1101, which includes one or more dots in a 2×3 position array. Each Braille symbol 1101 can be presented by one of wearable rings 1110. For example, the Braille symbol corresponding to “H” can be presented to a ring 1110 worn on a first finger, the Braille symbol corresponding to “e” can be presented to a ring 1110 worn on a second finger, the Braille symbol corresponding to “1” can be presented to two rings 1110 worn on a third and a fourth finger, respectively, etc. When the characters in the sentence are more than the number of rings (e.g., eight rings being worn on eight different fingers), the sentence can be presented in multiple periods. For example, in the first period, the rings 1110 can present the Braille symbols corresponding to H-e-l-l-o-space-h. In the second period, the rings 1110 can present the Braille symbols corresponding to o-w-space-a-r-e-space-y. In the third period, the rings 1110 can present the Braille symbols corresponding to o-u-space-?.

As shown in FIG. 11B, each wearable ring 1110 includes a 2×3 peg array 1120 corresponding to the dot positions of a Braille symbol. Each peg in the array corresponds to one of the dot positions and can be independently controlled by the control signal to move to the raised position (e.g., by a “1” in the control signal) to signify the presence of the dot, or move back to the flat position (e.g., by a “0” in the control signal) to signify an absence of a dot at the position. Thus, a set of control signals 1-0-1-1-0-0 for the corresponding peg positions in the peg array 1120 can be used to control the peg array 1120 to form the Braille symbol for the letter “H”. Similarly, a set of control signals 1-0-0-1-0-0 for the corresponding peg positions in the peg array 1120 can be used to control the peg array 1120 to form the Braille symbol for the letter “E”. A set of control signals 1-0-1-0-1-0 for the corresponding peg positions in the peg array 1120 can be used to control the peg array 1120 to form the Braille symbol for the letter “L”. A set of control signals 1-0-0-1-1-0 for the corresponding peg positions in the peg array 1120 can be used to control the peg array 1120 to form the Braille symbol for the letter “0”.

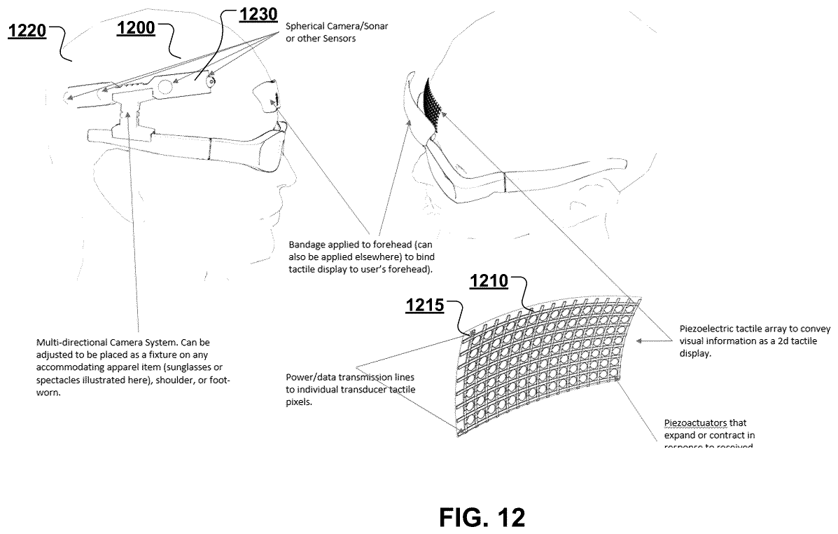

FIG. 12 shows another example of the presentation device 1200. In particular, the presentation device 1200 includes a contoured piezoelectric haptic array 1210 that can be placed (e.g., attached using an adhesive) in contact with the forehead of the user 1220 to serve as a tactile display. The piezoelectric haptic array 1210 receives data collected by the sensing device 1230, e.g., a camera, a sonar, or another type of sensor attached to a pair of goggles 1240. The piezoelectric haptic array 1210 can present the collected data by forming tactile patterns that the user can sense, e.g., via the forehead. For example, the piezoelectric haptic array elements 1215 can be controlled to provide haptic feedback, e.g., vibrations to form the tactile pattern to deliver information to the user 1220. The tactile pattern can include text (e.g., Braille-type text), images, diagrams, symbols, or other graphic elements that have pre-defined meaning to the user. For example, the tactile pattern can present a diagram of a simplified map showing directions of roads, locations of cross sections, locations and directions of pedestrian crossings, road signs, and/or street names. In some implementations, the tactile patterns can be dynamic patterns that change over multiple time points. For example, the piezoelectric haptic array can present a dynamic pattern that depicts the position and movements of an object (e.g., a vehicle) in the environment.

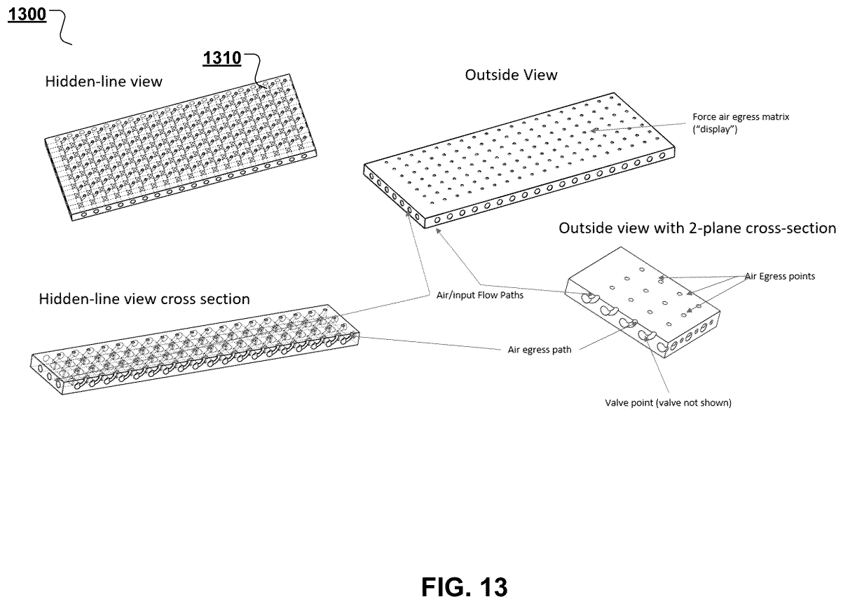

FIG. 13 shows another example of a presentation device 1300 including a haptic array 1310. In particular, the haptic array 1310 can present a tactile image formed by controlling a plurality of valves in micro-fluidic or pneumatic channels to route forced air or liquid flow in the channels. The valves can control the flow of air or fluid to form pressure or vibration points at particular positions in the haptic array 1310, which provide tactile sensations at the corresponding positions when the haptic array 1310 is placed in contact with a part of a user. Similar to the piezoelectric haptic array described with reference to FIG. 12, the haptic array 1310 can present a tactile pattern that includes text (e.g., Braille-type text), images, diagrams, symbols, or other graphic elements that have pre-defined meaning to the user.

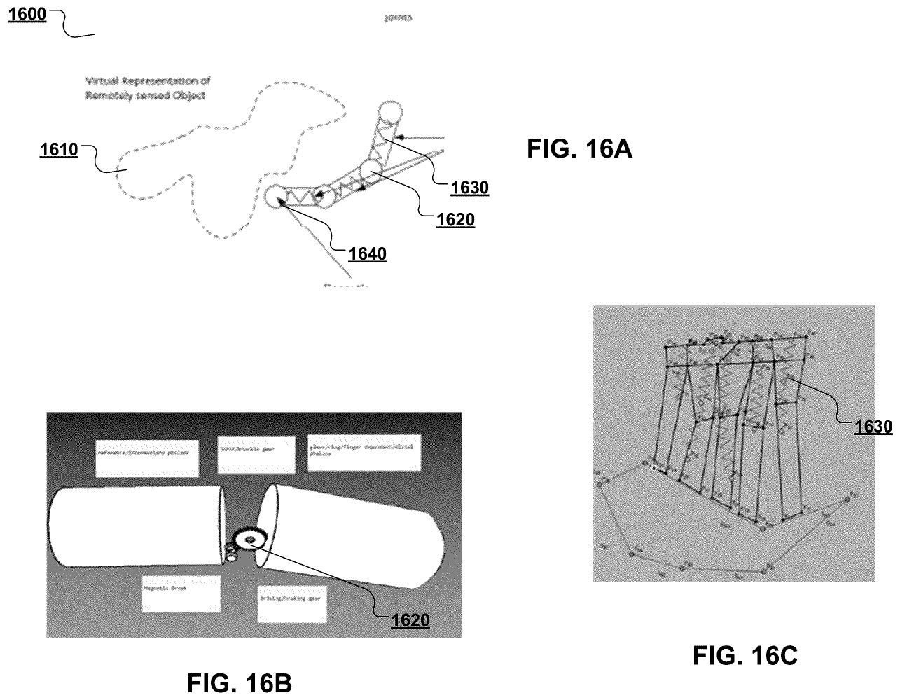

FIGS. 16A, 16B, and 16C illustrate an example of another presentation device 1600 that comprises a wearable device configured to convey 3D shapes through haptic feedback. The presentation device 1600 allows users, particularly the visually impaired, to experience and understand three-dimensional forms in a tactile and intuitive manner.

The presentation device 1600 can include a glove configured with mechanics 1620 on each finger joint and connection mechanisms 1630 connecting the joint mechanics 1620. When a user wears the glove and moves their fingers as if they were tracing a 3D object 1610, the device simulates the object's presence by providing varying degrees of resistance, provided by the connection mechanisms 1630. This resistance is consistent with the contours, edges, and surfaces of the reproduced 3D shape, thus offering the sensation of interacting with a tangible object. This glove replicates the feeling of touch and resistance one would naturally experience while exploring a physical object.

An alternative embodiment involves rings designed to be worn over the finger joints. These rings are interconnected with each other and equipped with responsive mechanics (e.g., the connection mechanisms). As a user moves their fingers to explore the perceived shape, these rings provide resistance similar to the glove-based device, simulating the 3D object's presence.

The connection mechanisms 1630 can use actuators to provide haptic feedback to the user. The actuators can be motors, pneumatic actuators, or other devices that can create forces or vibrations. The joint mechanism 1620 can include gears to control and/or allow the movement of the joint.

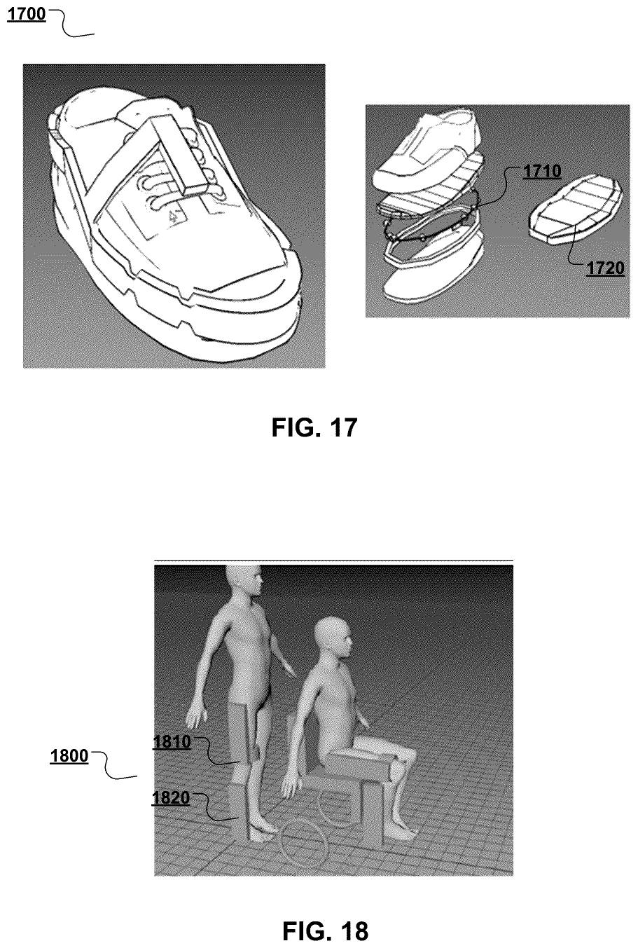

FIG. 17 illustrates another presentation device that includes a shoe 1700 designed to provide haptic feedback for visually impaired individuals, enhancing their navigational capabilities. The shoe 1700 includes vibration elements 1710 within the sole 1720. The vibration elements 1710 can be controlled by a control unit to relay vibration patterns for providing intuitive direction cues for the wearer.

For example, a vibration in the heel region can signal the user to proceed forward, while a vibration in the toe area can indicate the need to halt. Similarly, vibratory signals on the left and right sides of the shoe can guide the user to shift their movement to the left or right, respectively. This haptic presentation device provides a tactile and non-intrusive method for visually impaired individuals to navigate various terrains and environments with increased confidence and safety.

FIG. 18 illustrates another presentation device that includes a wearable device 1800 designed to help visually impaired individuals move and find their way in different settings. The wearable device 1800 can include a thigh cuff 1810, and a lower leg cuff 1820, and a joint mechanism (now shown). The thigh cuff 1810 can be fixed around the upper leg of the user, and the lower leg cuff 1820 can be placed around the lower leg of the user. The two cuffs are connected by the joint mechanism that has actuators configured to move based on control signals.

In one application scenario, a voice command component of the apparatus 100 allows the user to give directions or actions. The sensing device 110 can survey the surroundings, noting things like obstacles, ground changes, and the position of specific items or locations. The processing device 120 processes the user's spoken commands and data from the sensors, then sends the signals to the joint mechanism of the wearable device 1800 to guide the user's steps.

For example, the user can say “Take me to my wheelchair.” The sensing device 110 surveys the environment for the wheelchair's location and find a safe path to it. The processing device 120 will then process this information and guide the joint mechanism, directing the user's legs toward the wheelchair. When close, the wearable device 1800 will help the user to sit down. The wearable device 1800 can also be used to guide the user to other locations, such as a door, a table, or a bathroom. The user can give the appropriate commands, and the wearable device 1800 will help the user perform the actions following the commands.

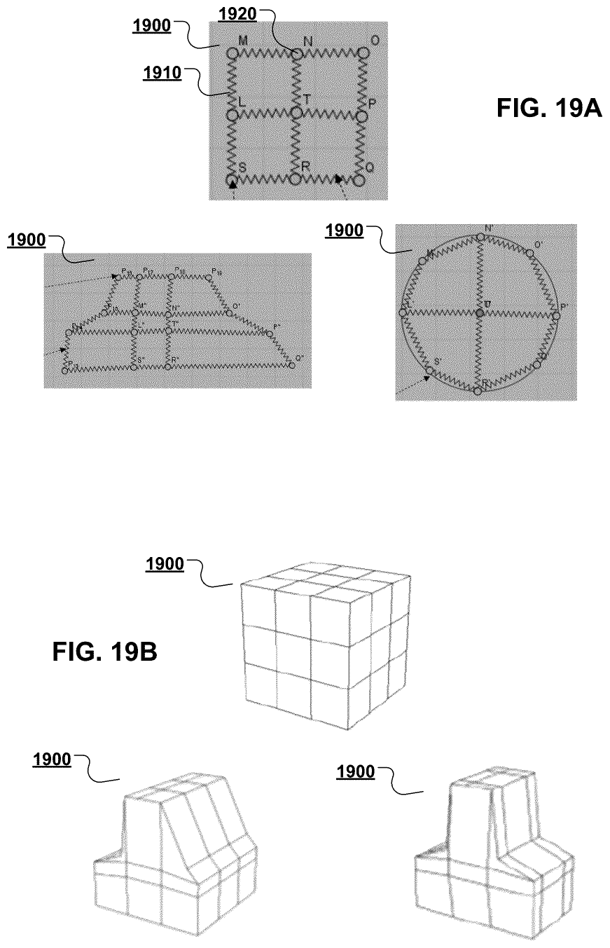

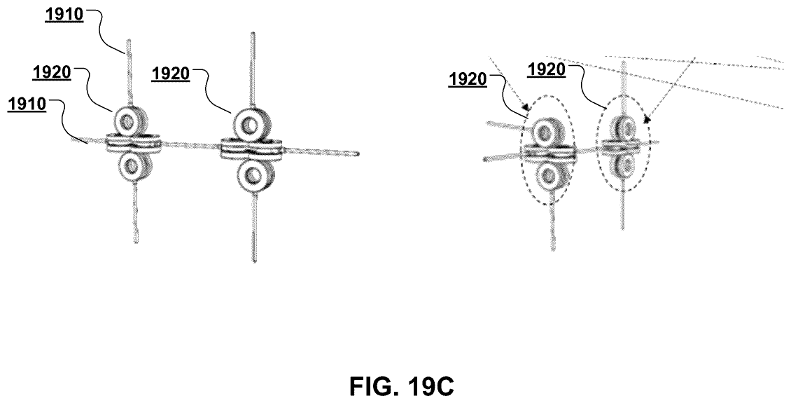

FIGS. 19A, 19B, and 19C illustrate another presentation device that includes a shape presentation device 1900 designed to represent 3D shapes for visually impaired individuals. The shape presentation device 1900 includes a 3D grid of rod elements 1910 interconnected at node elements 1920. The node elements 1920 act as joints, providing the rod elements 1910 with multiple degrees of freedom for various orientations. An implementation of the node elements 1920 is illustrated in FIG. 19C, where each node includes re-angling cylinders. The rod elements 1910 can include telescoping mechanisms, enabling length adjustments of the rod elements 1910. The node elements 1920 and/or the telescoping mechanisms can be integrated with actuators, which allow the device 1900 to change its shape based on control signals. Through this configuration, the device 1900 can offer a tactile means for visually impaired users to understand different 3D structures and forms.

For example, to represent a cube, the device 1900 can be configured to have six rod elements 1910 connected to each node element 1920. The rod elements 1910 would be extended to the same length, and the node elements 1920 would be locked in place. To represent a sphere, the rod elements 1910 would be extended to different lengths.

The device 1900 can be controlled by a computer or a mobile device, e.g., by the processing device 120 of the apparatus 100. The processing device 120 can select the shape to be represented, and send control signals to the actuators of the rod elements 1910 and/or the node elements 1920. The actuators can then move the rod elements 1910 and node elements 1920 to change the shape of the device 1900.

The device 1900 is a valuable tool for visually impaired people, as it would allow them to explore 3D shapes in a tactile way.

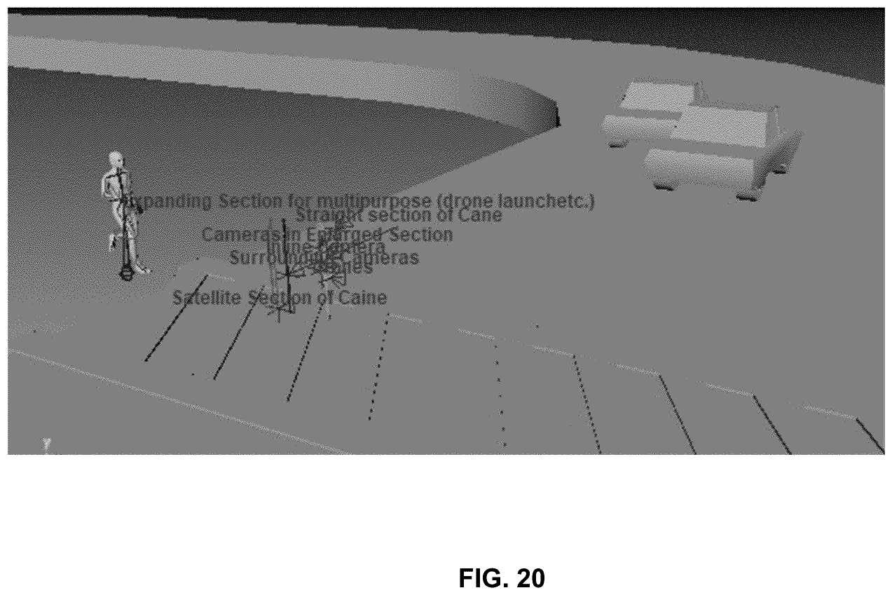

FIG. 20 shows a user using an example of an assistive apparatus to navigate the environment. The sensing device (e.g., a walking stick incorporated with one or more sensors) collects sensor data of the environment for characterizing static (e.g., streets and buildings) and dynamic objects (moving vehicles) in the environment, and transmits the sensor data to the processing device. The processing device can use the collected sensor data, and optionally data received from the data repository, to generate presentation data, e.g., in the form of audio signals and/or haptic signals. The presentation device, e.g., audio speakers, haptic arrays, haptic rings, etc., can present the data to the user in real time.

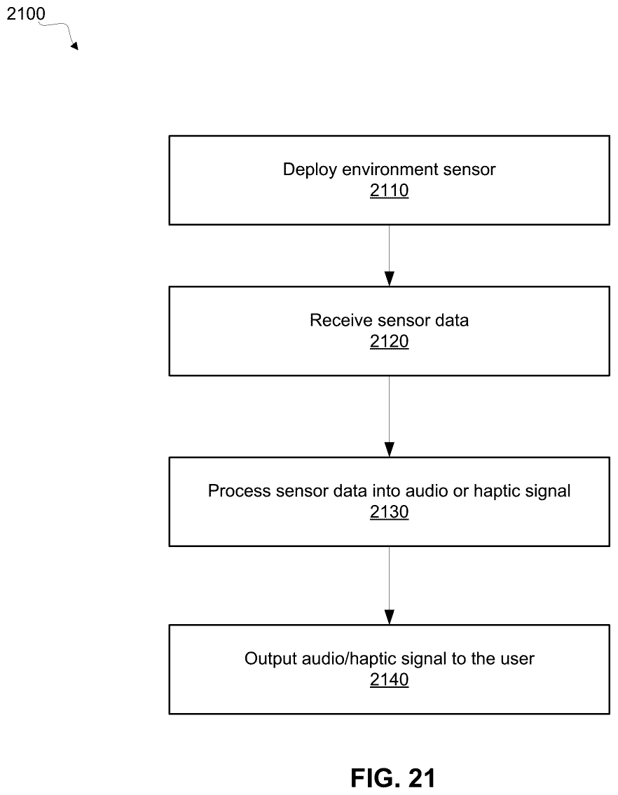

FIG. 21 shows a method for providing assistance to a user by using any examples of the assistive apparatus described above. The method includes deploying a sensor to collect data from an environment (step 2110), receiving the collected data from the sensor (step 2120), processing the sensor data into audio or haptic signals (step 2130), and output the audio/haptic signals to the user (step 2140).

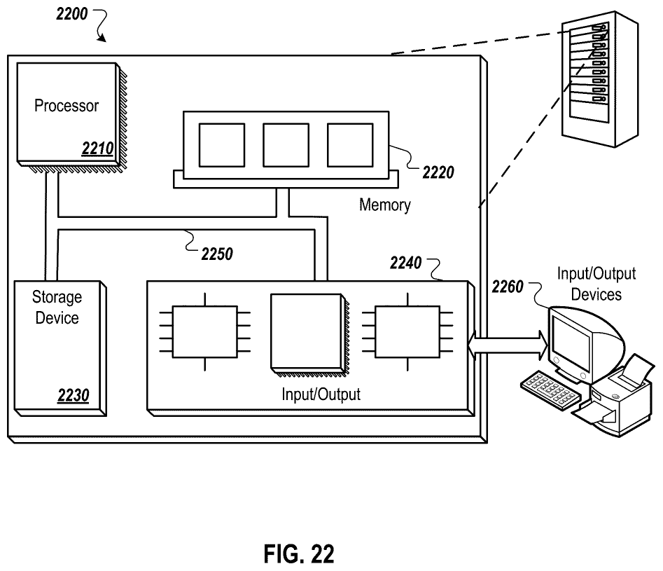

FIG. 22 shows an example of a computer system 2200 that can be used as a processing device. The system 2200 includes a processor 2210, a memory 2220, a storage device 2230, and an input/output device 2240. Each of the components 2210, 2220, 2230, and 2240 can be interconnected, for example, using a system bus 2250. The processor 2210 is capable of processing instructions for execution within the system 2200. In one implementation, the processor 2210 is a single-threaded processor. In another implementation, the processor 2210 is a multi-threaded processor. The processor 2210 is capable of processing instructions stored in the memory 2220 or on the storage device 2230.

The memory 2220 stores information within the system 2200. In one implementation, the memory 2220 is a computer-readable medium. In one implementation, the memory 2220 is a volatile memory unit. In another implementation, the memory 2220 is a non-volatile memory unit.

The storage device 2230 is capable of providing mass storage for the system 2200. In one implementation, the storage device 2230 is a computer-readable medium. In various different implementations, the storage device 2230 can include, for example, a hard disk device, an optical disk device, a storage device that is shared over a network by multiple computing devices (for example, a cloud storage device), or some other large-capacity storage device.

The input/output device 2240 provides input/output operations for the system 2200. In one implementation, the input/output device 2240 can include one or more network interface devices, for example, an Ethernet card, a serial communication device, for example, a RS-232 port, and/or a wireless interface device. In another implementation, the input/output device can include driver devices configured to receive input data and send output data to other input/output devices, for example, keyboard, printer and display devices 2260. Other implementations, however, can also be used, such as mobile computing devices, mobile communication devices, set-top box television client devices, etc.

Although an example system has been described in FIG. 22, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by a data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, that is, one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, for example, a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, for example, an FPGA (field programmable gate array) or an ASIC (application-specific integrated circuit). The apparatus can optionally include, in addition to hardware, code that creates an execution environment for computer programs, for example, code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, for example, an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device, for example, a universal serial bus (USB) flash drive, to name just a few.

Computer-readable media suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks.

To provide for interaction with a user, embodiments of the subject matter described in this specification can be implemented on a computer having a display device, for example, a CRT (cathode ray tube) or LCD (liquid crystal display) monitor, for displaying information to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of messages to a personal device, for example, a smartphone that is running a messaging application and receiving responsive messages from the user in return.

Data processing apparatus for implementing machine learning models can also include, for example, special-purpose hardware accelerator units for processing common and compute-intensive parts of machine learning training or production, that is, inference, workloads.

Embodiments of the subject matter described in this specification can be implemented in a computing system that includes a back-end component, for example, as a data server, or that includes a middleware component, for example, an application server, or that includes a front-end component, for example, a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, for example, a communication network. Examples of communication networks include a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, for example, an HTML, page, to a user device, for example, for purposes of displaying data to and receiving user input from a user interacting with the device, which acts as a client. Data generated at the user device, for example, a result of the user interaction, can be received at the server from the device.

While this specification contains many specific implementation details, these should not be construed as limitations on the scope of any features or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An assistive apparatus, comprising:
a sensing device configured to collect data characterizing an environment in the vicinity of a user, the collected data being of a first data type;
a processing device, including one or more processors, configured to process an input including the collected data into presentation data specifying one or more of: an audio signal or a haptic signal; and
a presentation device configured to deliver the audio signal or the haptic signal to the user.

2. The assistive apparatus of claim 1, wherein the sensing device includes one or more of: a camera, a sonar, or a Lidar.

3. The assistive apparatus of claim 1, wherein the sensing device is further configured to transmit the collected data to a data repository shared by multiple users, and the processing device is further configured to receive data from the data repository and process the received data into the presentation data.

4. The assistive apparatus of claim 1, wherein the sensing device includes an unmanned aerial vehicle (UAV) configured to:
navigate the environment in the vicinity of the user;
collect sensor data using a sensor onboard the UAV; and
transmit the sensor data to the processing device.

5. The assistive apparatus of claim 4, wherein the sensor includes one or more of: a camera, a sonar, or a Lidar.

6. The assistive apparatus of claim 4, wherein the UAV comprises a control unit, including one or more processors, configured to:
control the UAV to be deployed to navigate the environment in the vicinity of the user;
and control the UAV to return to a storage housing of a wearable device when the UAV is not being deployed.

7. The assistive apparatus of claim 6, wherein the control unit is further configured to control one or more actuators to rearrange a structure of the UAV between a resting configuration for storage and a deployed configuration for flight tasks.

8. The assistive apparatus of claim 7, wherein the UAV includes a plurality of rotor discs, and rearranging the UAV from the deployed configuration to the resting configuration comprises:
rearranging one or more respective rotation axles of one or more of the plurality of rotor discs to align the rotation axles into a linear alignment with each other.

9. The assistive apparatus of claim 7, wherein the UAV includes a frame structure that has an elongated shape in the resting configuration, and rearranging the UAV from the resting configuration to the deployed configuration comprises expanding a width and shortening a height of the elongated shape of the frame structure.

10. The assistive apparatus of claim 7, wherein the UAV has a spherical shape when in the resting configuration, and rearranging the UAV from the resting configuration to the deployed configuration comprises moving one or more movable portions of the spherical shape from a closed to an open position.

11. The assistive apparatus of claim 7, wherein:
the UAV comprises one or more propellers each including a plurality of rectangular blades rotatably coupled to an axle, and the plurality of rectangular blades are aligned with each other when the UAV is in a resting configuration.

12. The assistive apparatus of claim 4, further comprising a UAV launching device, the UAV launching device comprising:
a barrel configured to house and guide the UAV during launching; and
an ejection mechanism configured to eject the UAV.

13. The assistive apparatus of claim 1, wherein the sensing device includes a walking stick incorporated with one or more sensors configured to collect sensor data of the environment, and transmit the sensor data to the processing device.

14. The assistive apparatus of claim 13, wherein the one or more sensors incorporated into the walking stick comprises one or more of:
one or more cameras;
a GPS device; or
a UAV housed in a storage housing of the elongated pole when the UAV is in a resting position.

15. The assistive apparatus of claim 13, wherein the elongated pole comprises a plurality of sections coupled together and configured to expand from a retracted to an expanded configuration.

16. The assistive apparatus of claim 1, wherein the sensing device includes a mobile robotic device configured to:
navigate the environment in the vicinity of the user;
collect sensor data using a sensor onboard the mobile robotic device; and
transmit the sensor data to the processing device.

17. The assistive apparatus of claim 16, wherein the mobile robotic device is connected to an expandable tether.

18. The assistive apparatus of claim 16, wherein the mobile robotic device is further configured to be controlled by a voice command to perform a task.

19. The assistive apparatus of claim 1, wherein the presentation device includes one or more arrays of actuated pegs that are controlled, by a control signal generated according to the presentation data, to move in an axial direction to form one or more patterns.

20. The assistive apparatus of claim 19, wherein the one or more of the actuated pegs are further controlled by the control signal to provide a haptic feedback.

21. The assistive apparatus of claim 20, wherein the haptic feedback is a vibration.

22. The assistive apparatus of claim 19, wherein the processing device is configured to:
generate text data specifying a text segment based on the collected data;
process the text data to generate Braille data specifying a Braille text segment that is a translation of the text segment; and
process the Braille text segment to generate the control signal;
wherein the one or more array of actuated pegs are controlled by the control signal to form one or more patterns of Braille characters to present the Braille text segment to the user.

23. The assistive apparatus of claim 19, wherein each of the one or more arrays of actuated pegs are incorporated into one or more wearable rings.

24. The assistive apparatus of claim 19, wherein at least one of the one or more patterns is a dynamic pattern that changes over multiple time points.

25. The assistive apparatus of claim 24, wherein the dynamic pattern depicts dynamic features of the environment.

26. The assistive apparatus of claim 23, wherein the dynamic pattern depicts position and movements of an object in the environment.

27. The assistive apparatus of claim 1, wherein the presentation device includes a tactile image formed by controlling a plurality of valves in micro-fluidic or pneumatic channels to route forced air or liquid flow in the channels.

28. The assistive apparatus of claim 1, wherein the assistive apparatus is configured to receive a user command, and control the sensing device and the presentation device to perform operations according to the user command.

29. The assistive apparatus of claim 1, further comprising a brain signal sensing device, the brain signal sensing device comprising:
one or more sensors configured to measure signals from a user brain; and
an analysis unit, including one or more processors, configured to analyze the measured signals to infer a user intention, and generate the user command based on the inferred user intention.

30. The assistive apparatus of claim 29, wherein the one or more sensors are fixed on one or more rotatable frames to scan different locations.

31. The assistive apparatus of claim 29, wherein the analysis unit is configured to process an input specifying the measured signals using a machine-learning model to infer the user intention.

32. The assistive apparatus of claim 31, wherein the machine-learning model has been trained on a dataset of brain signals that have been labeled with corresponding user intentions.

33. The assistive apparatus of claim 1, wherein the presentation device comprises a wearable device for conveying 3D shapes through haptic feedback.

34. The assistive apparatus of claim 33, wherein the wearable device comprises:
a glove configured with mechanics on each finger joint;
connection mechanisms connecting the joint mechanics; and
actuators for providing haptic feedback to the user.

35. The assistive apparatus of claim 33, wherein the wearable device comprises:
rings configured to be worn over finger joints of the user;
connection mechanisms interconnecting the rings; and
actuators for providing haptic feedback to the user.

36. The assistive apparatus of claim 1, wherein the presentation device comprises a shoe for providing haptic feedback, the shoe comprising:
vibration elements within a sole of the shoe, wherein the vibration elements are configured to relay vibration patterns for providing direction cues for the user.

37. The assistive apparatus of claim 1, wherein the presentation device comprises a wearable device for assisting movements of the user, the wearable device comprising:
a thigh cuff;
a lower leg cuff;
a joint mechanism connecting the thigh cuff and the lower leg cuff; and
actuators in the joint mechanism configured to move based on control signals.

38. The assistive apparatus of claim 1, wherein the presentation device comprises a shape presentation device, shape presentation device comprising:
a 3D grid of rod elements interconnected by node elements;
telescoping mechanisms for adjusting lengths of the rod elements; and
actuators configured to reshape the 3D grid.

39. An assistive method being performed by using the assistive apparatus of claim 1, the assistive method comprising:
deploying a sensor to collect data from the environment;
receiving the collected data from the sensor;
processing the sensor data into audio or haptic signals; and
outputting the audio and/or the haptic signals to the user.
